(19) United States
(12) Patent Application Publication
(10) Pub. No.: US 2017/0079033 A1
(43) Pub. Date: Mar. 16, 2017

(54) TRANSMISSION RESOURCE DETERMINING METHOD, ACCESS POINT, AND STATION

(71) Applicant: HUAWEI TECHNOLOGIES CO., LTD., Shenzhen (CN)

(72) Inventors: Yingpei LIN, Shanghai (CN); Jiayin ZHANG, Shanghai (CN); Jun LUO, Shanghai (CN)

(73) Assignee: HUAWEI TECHNOLOGIES CO., LTD., Shenzhen (CN)

(21) Appl. No.: 15/360,219

(22) Filed: Nov. 23, 2016

Related U.S. Application Data
(63) Continuation of application No. PCT/CN2014/078573, filed on May 27, 2014.

(51) Int. Cl. H04W 72/04; H04W 72/12

(52) U.S. Cl. CPC H04W 72/0446; H04W 72/1252; H04W 72/0453; H04W 72/1257; H04W 84/12

(57) ABSTRACT

This application provides a transmission resource determining method, an access point, and a station, where the method includes: determining, by a wireless local area network access point, transmission resource information of first M transmission timeslots in a schedule window when obtaining a right of using a channel, where the channel is a wireless channel in an unlicensed frequency band, and M is a positive integer; and sending, by the access point, the transmission resource information to a station STA after entering the schedule window. According to the method, quality of service QoS of a service that needs to be transmitted periodically or transmitted persistently can be ensured.

### CROSS-REFERENCE TO RELATED APPLICATIONS

This application is a continuation of International Application No. PCT/CN2014/078573, filed on May 27, 2014, the disclosure of which is hereby incorporated by reference in its entirety.

### TECHNICAL FIELD

This application relates to the field of communications technologies, and in particular, to a transmission resource determining method, an access point, and a station.

### BACKGROUND

As network technologies and mobile devices rapidly develop, a WLAN (Wireless Local Area Network) technology based on the IEEE 802.11 standard is greatly developed and widely applied. Nowadays, more than 17% of the world's population uses WiFi (Wireless Fidelity) for network connection, and each year there are more than one billion WiFi devices delivered to markets. WiFi networks deployed in homes, hotspots, and enterprises and deployed by operators can be found everywhere. There is an increasing popularity of intelligent terminals having a WLAN function, such as a portable computer, a tablet, a smartphone, a digital camera, and a media player. These intelligent terminals bring convenience to people's work and life, and on the other hand, also bring a great challenge for the development of the WLAN technology.

### SUMMARY

This application provides a transmission resource determining method, an access point, and a station, so as to resolve a technical problem in the prior art: when an unlicensed frequency band is used to transmit a service that needs to be scheduled periodically or persistently, QoS is difficult to be ensured because of an uncertainty of the unlicensed frequency band.

A first aspect of this application provides a transmission resource determining method, where the method includes:

determining, by a wireless local area network access point, transmission resource information of first M transmission timeslots in a schedule window when obtaining a right of using a channel, where the channel is a wireless channel in an unlicensed frequency band, and M is a positive integer; and sending, by the access point, the transmission resource information to a station STA after entering the schedule window.

A second aspect of this application further provides a transmission resource determining method, where the method includes:

receiving, by a station STA, transmission resource information sent by a wireless local area network access point, where the transmission resource information is specifically transmission resource information that is of first M transmission timeslots in a schedule window and determined by the access point when the access point obtains a right of using a channel, and M is a positive integer; and

determining, by the STA, a transmission resource of the STA according to the transmission resource information, where the transmission resource is a transmission resource in an unlicensed frequency band.

A third aspect of this application provides a wireless local area network access point, where the access point includes:

a processing unit, configured to determine transmission resource information of first M transmission timeslots in a schedule window when obtaining a right of using a channel, where the channel is a wireless channel in an unlicensed frequency band, and M is a positive integer; and a sending unit, configured to send the transmission resource information to a station STA after the access point enters the schedule window.

A fourth aspect of this application provides a station, where the station includes:

a receiving unit, configured to receive transmission resource information sent by a wireless local area network access point, where the transmission resource information is specifically transmission resource information that is of first M transmission timeslots in a schedule window and determined by the access point when the access point obtains a right of using a channel, and M is a positive integer; and

a determining unit, configured to determine a transmission resource of the station according to the transmission resource information, where the transmission resource is a transmission resource in an unlicensed frequency band.

A fifth aspect of this application further provides a wireless local area network access point, where the access point includes:

a processor, configured to determine transmission resource information of first M transmission timeslots in a schedule window when obtaining a right of using a channel, where the channel is a wireless channel in an unlicensed frequency band, and M is a positive integer; and a transmitter, configured to send the transmission resource information to a station STA after the access point enters the schedule window.

A sixth aspect of this application provides a station, where the station includes:

a receiver, configured to receive transmission resource information sent by a wireless local area network access point, where the transmission resource information is specifically transmission resource information that is of first M transmission timeslots in a schedule window and determined by the access point when the access point obtains a right of using a channel, and M is a positive integer; and

a processor, configured to determine a transmission resource of the station according to the transmission resource information, where the transmission resource is a transmission resource in an unlicensed frequency band.

One or more technical solutions provided in the embodiments of this application have at least the following technical effects or advantages:

In the transmission resource determining method provided in the embodiments of this application, when obtaining a right of using a channel, an access point determines transmission resource information of first M transmission timeslots starting from the first timeslot in a schedule window; and the access point sends the transmission resource information to a station STA after entering the schedule window. Therefore, in the embodiments, when obtaining the right of using the channel, the access point determines information about a transmission resource allocated to the STA in each transmission timeslot, such as a size and a location of a resource, and therefore, this transmission resource determining manner is more flexible, can better meet a transmission requirement of the STA, and can ensure quality of service QoS for a service that needs to be transmitted periodically or transmitted persistently.

### BRIEF DESCRIPTION OF DRAWINGS

FIG. 1a is a schematic diagram of performing scheduling-based access in an unlicensed frequency band;

FIG. 1b is a schematic diagram of uplink/downlink distribution of a data frame in an unlicensed frequency band;

FIG. 2a to FIG. 2c are schematic diagrams of several possible cases in a process of performing scheduling-based access in an unlicensed frequency band;

FIG. 3 is a flowchart of a transmission resource determining method on an access point side according to an embodiment of this application;

FIG. 4 is a flowchart of a transmission resource determining method on a station side according to an embodiment of this application;

FIG. 5 is a flowchart of a possible interaction between an access point side and a station side in a transmission resource determining method according to an embodiment of this application;

FIG. 6 is a schematic diagram of a transmission resource allocated to a station according to an embodiment of this application;

FIG. 7 is a schematic diagram of a transmission resource allocated to a station according to another embodiment of this application;

FIG. 8 is a schematic diagram of a transmission resource allocated to a station according to still another embodiment of this application;

FIG. 9 is a functional block diagram of an access point according to an embodiment of this application;

FIG. 10 is a concept diagram of an instance of hardware implementation of an access point according to an embodiment of this application;

FIG. 11 is a functional block diagram of a station according to an embodiment of this application; and

FIG. 12 is a concept diagram of an instance of hardware implementation of a station according to an embodiment of this application.

### DESCRIPTION OF EMBODIMENTS

Embodiments of the this application provide a transmission resource determining method, an access point, and a station, so as to resolve a prior-art technical problem that QoS is relatively low when an unlicensed frequency band is used to transmit a service that needs to be scheduled periodically or persistently because of an uncertainty of the unlicensed frequency band.

A station mentioned in this specification may also be referred to as an access terminal, a system, a user unit, a user station, a mobile station, a mobile, a remote station, a remote terminal, a mobile device, a user terminal, a terminal, a wireless communications device, a user agent, a user apparatus, UE (User Equipment, user equipment), or the like. The station may be a cellular phone, a cordless phone, a SIP (Session Initiation Protocol, Session Initiation Protocol) phone, a WLL (Wireless Local Loop, wireless local loop) station, a PDA (Personal Digital Assistant, personal digital assistant), a handheld device that has a wireless communication function, a computing device, or another processing device connected to a wireless modem.

In addition, a wireless local area network access point in this specification may be an access point that independently uses a WLAN (Wireless Local Area Network, wireless local area network) technology; may be combined with an existing base station, for example, combined with a BTS (Base Transceiver Station, base transceiver station) in GSM (Global System for Mobile Communications) or CDMA (Code Division Multiple Access), or may be combined with an NB (NodeB, NodeB) in WCDMA (Wideband Code Division Multiple Access); or may be an eNB or an eNodeB (Evolutional Node B, evolved NodeB) in LTE (Long Term Evolution), a relay station, an access point, a base station device in a future 5G network, or the like.

It should be understood that in this specification, a term “and/or” is only an associative relationship for describing associated objects, indicating that three relationships may exist, for example, A and/or B, which may indicate three situations: A exists independently; A and B exist simultaneously; and B exists independently. In addition, in this specification, a character “/” generally indicates an “or” relationship between a former and a latter associated objects.

An unlicensed frequency band free of charge is used in a WLAN network. Spectrum utilization and network efficiency are low because of a characteristic of this open spectrum and a contention-based access mechanism of the WLAN. Spectrum usage efficiency may be effectively improved by using a scheduling-based access mechanism. Referring to FIG. 1a, FIG. 1a is a schematic diagram of a method for performing scheduling-based access in an unlicensed frequency band. A channel is reserved for a period of time after the channel is successfully obtained by means of contention, and then scheduling-based access is performed in this period of time. For example, the patent application PCT/CN2014/072617 that is of the applicant and filed on Feb. 27, 2014 provides a corresponding apparatus and method to implement the method of performing scheduling-based access in an unlicensed frequency band, and is incorporated herein by reference in its entirety.

Referring to FIG. 1b, in a scheduling-based access mechanism, a data frame is transmitted according to a TDD (Time Division Duplexing,) mode in which an uplink and a downlink are separate. In a licensed frequency band, for example, in an LTE (Long Term Evolution) system, after initial configuration of uplink and downlink timeslots is completed, uplink/downlink transmission is performed according to the configuration, and uplink transmission is certainly performed at a time point that is an uplink time point. Different from a mode of operation in a licensed frequency band such as LTE, in an unlicensed frequency band, if there are few uplink services, there may be no subsequent uplink timeslot, such as an uplink timeslot represented by a dashed box in FIG. 1b. Because no service needs to be sent, in this period of time, because of an attribute of the unlicensed frequency band, a channel needs to be released or a time of a next radio frame needs to be entered. The TTG in FIG. 1b means a Transmit/Receive Transition Gap.

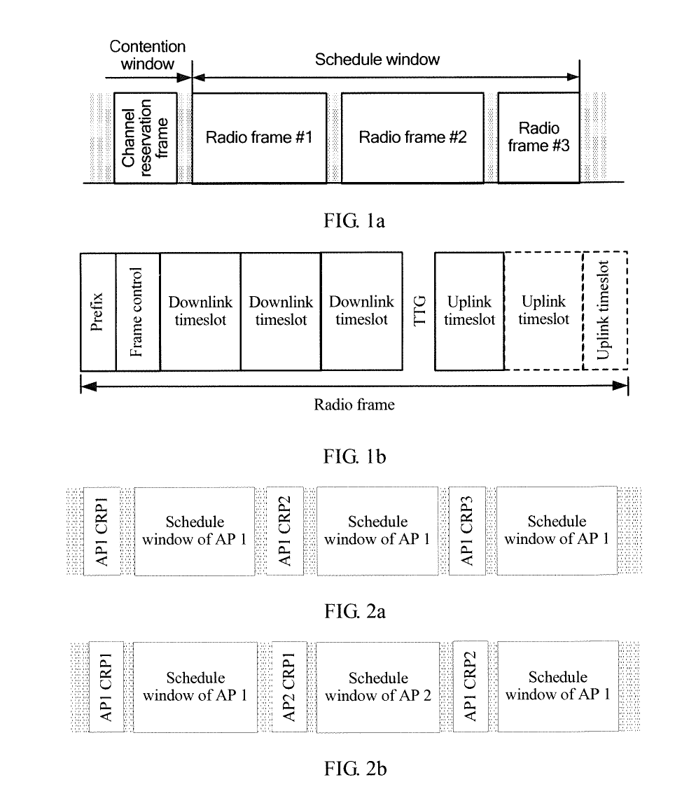

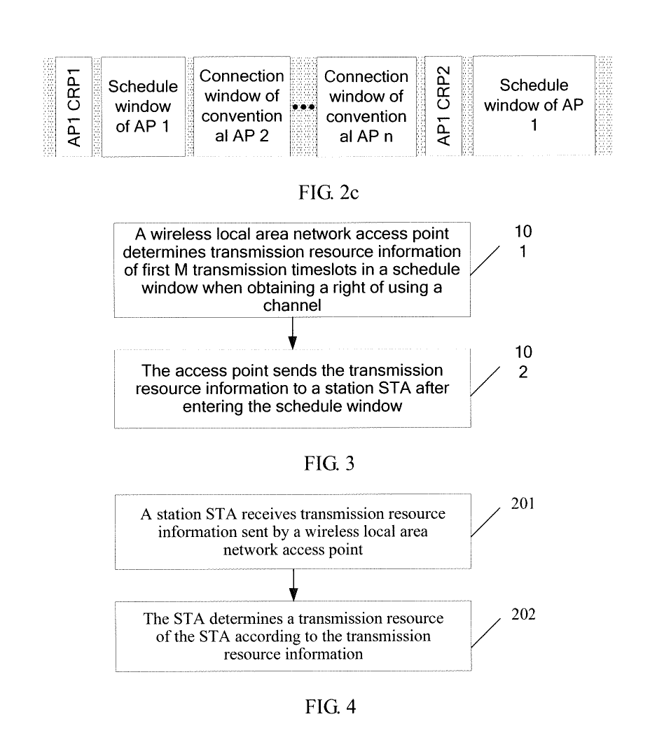

In addition, because of a rule of using the unlicensed frequency band, many uncertain factors occur in a process of reserving a channel by an AP (Access Point) by using the mechanism in FIG. 1a. As shown in FIG. 2a, if load on a channel is light or few neighboring APs operate on a same channel on which the AP operates, the AP may access the channel as required throughout or most of the time. However, in a dense deployment scenario, because of more neighboring APs, the channel is very likely to be occupied by another AP after one schedule window ends. For example, a channel in FIG. 2b is occupied by an AP that has a scheduling function, and a channel in FIG. 2c is occupied by another legacy AP. This causes an uncertainty about accessing a channel by the AP. The CRPs in FIG. 2a to FIG. 2c represent channel reservation packets.

Because of the foregoing two uncertainties: an uncertainty of a scheduling time period and an uncertainty of an uplink timeslot, transmission in an unlicensed frequency band cannot be scheduled periodically. Therefore, for a service that needs to be scheduled periodically or persistently, QoS (Quality of Service) of the service is difficult to ensure.

For a WLAN network in which application scenarios shown in FIG. 1a and FIG. 1b, and FIG. 2a to FIG. 2c are used as examples, the embodiments provide a transmission resource determining method, which provides a feasible method for performing periodic scheduling in a process of communication in an unlicensed frequency band. Referring to FIG. 3, FIG. 3 is a flowchart of a transmission resource determining method according to an embodiment, where the method includes the following content:

Step 101: An access point determines transmission resource information of first M transmission timeslots in a schedule window when obtaining a right of using a channel, where M is a positive integer.

Step 102: The access point sends the transmission resource information to a station (STA) after entering the schedule window.

Obtaining, by the access point, the right of using the channel may include but is not limited to the following two cases: One case is that the access point successfully obtains the channel by means of contention; the other case is that after successfully obtaining the channel by means of contention, the STA notifies the access point.

In step 101, the access point determines the transmission resource information of the first M transmission timeslots in the schedule window. Specifically, the access point determines the transmission resource information of the first M transmission timeslots in the schedule window according to a network status or a service requirement, which is specifically, for example, channel contention information.

For a value of M, a possible case is: a specific value of M may be a preset value, and may be set to any value from 1 to a maximum quantity of transmission timeslots in the schedule window. Another possible case is: as described above in FIG. 1b, because of the uncertainty of the uplink timeslot, a quantity of transmission slots needs to be determined. For example, the quantity of transmission timeslots is determined according to contention information. If a time consumed for contending for the channel is relatively long, the station STA may buffer a relatively large amount of data. Because buffered data possibly cannot be completely borne in only the first transmission timeslot, the access point determines transmission resource information of more transmission timeslots for use by STA. For example, if a time consumed for contention is 5 ms to 10 ms, transmission resource information of the first transmission timeslot is determined; if a time consumed for contention is 10 ms to 15 ms, transmission resource information of first two transmission timeslots may be determined. Determining the transmission resource information includes but is not limited to determining a size and/or a location of a transmission resource, or indication information of a transmission resource, where the indication information may be a resource scheduling mode.

It should be noted that a quantity of timeslots that are of the M transmission timeslots and can be used when the STA sends data depends on a quantity of packets of the STA, and an uplink transmission timeslot exists when uplink data needs to be transmitted. There is a similar case for a downlink transmission timeslot.

In a specific implementation process, step 101 specifically includes: determining, by the access point, the transmission resource information of the first M transmission timeslots in the schedule window according to channel contention information, specifically, for example, according to a time consumed for contention and/or bandwidth obtained by means of contention. For example, if a time consumed for contention is longer and/or bandwidth obtained by means of contention is lower, more transmission resources need to be configured for the STA to transmit buffered data brought by channel contention.

A specific example in which only the time consumed for contention is considered is used. It is assumed that when the transmission resource information of the first M transmission timeslots is determined at a previous time, two PRBs (Physical Resource Block, physical resource block) are allocated, in the first uplink timeslot, to each STA that performs periodic and persistent scheduling. If a time consumed for current contention is 5 ms to 10 ms, four PRBs may be allocated, in the first uplink transmission timeslot, to each STA that performs periodic and persistent scheduling, and two PRBs are allocated, in each of the following M-1 uplink timeslots, to each STA that performs periodic and persistent scheduling. If a time consumed for contention is 10 ms to 15 ms, four PRBs may be allocated, in each of the first and the second uplink transmission timeslots, to each STA that performs periodic and persistent scheduling, and two PRBs are allocated, in each of the following M-2 uplink timeslots, to each STA that performs periodic and persistent scheduling.

Optionally, the transmission resource information may specifically be resource configuration information directly, and includes but is not limited to a size and/or a location of a transmission resource, or may be indication information that indicates a transmission resource. Generally, a data amount required for transmitting the indication information is far less than a data amount required for directly transmitting the resource configuration information. Therefore, preferably, the indication information is used, so that scheduling overheads of the access point can be reduced, and transmission resource utilization can be improved.

After the access point determines the transmission resource information of the first M transmission timeslots, the access point performs step 102 of sending the transmission resource information to a station STA after entering the schedule window.

Optionally, the access point may send the transmission resource information to the STA by adding the transmission resource information to a start location of the schedule window. For example, the access point adds the transmission resource information to frame control information at a start location of a radio frame after entering the schedule window.

It can be learned from the foregoing description that, in this embodiment, each time an access point obtains a right of using a channel, the access point determines transmission resource information, such as a size or a location of a resource, of first M transmission timeslots in a schedule window. Therefore, this transmission resource determining manner is more flexible, can better meet a transmission requirement of a STA, and can ensure or improve quality of service QoS for a service that needs to be transmitted periodically or transmitted persistently.

Optionally, step 101 specifically includes: determining, by the access point from N resource scheduling modes specified in a protocol or predetermined, a resource scheduling mode used in one or more timeslots of the first M transmission timeslots as the transmission resource information of the first M transmission timeslots, where N is an integer greater than or equal to 2, and transmission resources corresponding to the N resource scheduling modes are not exactly the same as each other. In this embodiment, the determined resource scheduling mode is used as the indication information of the transmission resource of the first M transmission timeslots.

Further, determining, by the access point from the N resource scheduling modes, the resource scheduling mode used in the first M transmission timeslots includes: determining, by the access point from the N resource scheduling modes, one resource scheduling mode for each of the first M transmission timeslots. That is, each of the M transmission timeslots has a corresponding resource scheduling mode, and resource scheduling modes of every two timeslots may be the same, or may be different.

For example, a first resource scheduling mode is used in the first transmission timeslot, and in the first resource scheduling mode, a size of a transmission resource that can be used by each STA is four PRBs. A second resource scheduling mode is used in the second transmission timeslot, and in the second resource scheduling mode, a size of a transmission resource that can be used by each STA is two PRBs.

In this embodiment, the N resource scheduling modes may be specified in a protocol or predetermined. The access point selects, from the N resource scheduling modes according to contention information, a resource scheduling mode that matches a current network status, and then sends the resource scheduling mode to the STA by using step 102. After receiving the resource scheduling mode, the STA may determine a transmission resource that the STA needs to use, according to a status of the STA by using a correspondence between the resource scheduling mode and a transmission resource or according to a calculation rule of calculating a transmission resource according to a resource scheduling mode, where the correspondence and the calculation rule are previously sent by the access point or determined by means of negotiation in advance.

Specifically, when the access point previously sends the foregoing correspondence or calculation rule, before the access point obtains the right of using the channel, the method further includes: determining, by the access point, the N resource scheduling modes; calculating, by the access point, a transmission resource corresponding to each of the N resource scheduling modes; and sending, by the access point, correspondences between the N resource scheduling modes and the corresponding transmission resources or the calculation rule to the STA.

Optionally, the N resource scheduling modes are determined by using the following step: determining, by the access point, the N resource scheduling modes according to a channel condition and/or service load statistics. The channel condition includes but is not limited to: link quality, channel interference, and load on the channel. The link quality and the channel interference may be obtained, by means of measurement, in a process of communication between the access point and the STA, specifically, may be obtained by the access point by means of measurement, or may be reported to the access point after the STA performs measurement. The access point may specifically collect statistics about a duty cycle of the channel to determine the load on the channel. The service load may be specifically obtained by the access point by collecting statistics about load in a past period of time, such as a quantity of sent packets, a duty cycle of a service, and further, a quantity of packets of various services may be considered.

The determining, by the access point, the N resource scheduling modes according to a channel condition and/or service load statistics may be specifically: quantizing the channel condition and/or service load statistics, and determining the N resource scheduling modes according to different threshold ranges within which quantized values fall. Generally, a quantity of resource scheduling modes depends on a quantity of divided threshold ranges. For example, if two threshold ranges are obtained by means of division and are respectively a first threshold range and a second threshold range, the first threshold range is corresponding to a first resource scheduling mode, and the second threshold range is corresponding to a second resource scheduling mode.

Then, calculating, by the access point, transmission resources corresponding to the N resource scheduling modes is specifically: calculating the transmission resources according to channel conditions and/or service load statistics that are corresponding to the resource scheduling modes. For example, two resource scheduling modes are configured: A first resource scheduling mode is corresponding to a case of a better channel and/or lighter load, and the first resource scheduling mode may be corresponding to fewer resources, such as one PRB, of first resource configuration information; and a second resource scheduling mode is corresponding to a case of a worse channel and/or heavier load, and the second resource scheduling mode may be corresponding to more resources, such as two PRBs, of second resource configuration information.

That is, when the channel condition is a first channel condition and/or the service load statistics is first service load statistics, a first resource scheduling mode is determined, and a transmission resource corresponding to the first resource scheduling mode is a first transmission resource. When the channel condition is a second channel condition and/or the service load statistics is second service load statistics, a second resource scheduling mode is determined, and a transmission resource corresponding to the second resource scheduling mode is a second transmission resource. When the first channel condition is better than the second channel condition and/or a value of the first service load statistics is less than a value of the second service load statistics, a size of the first transmission resource is less than a size of the second transmission resource.

Then, the access point sends the correspondences between the N resource scheduling modes and the corresponding transmission resources or the calculation rule to the STA, for example, sends the correspondences or the calculation rule to the STA in a broadcast manner. For example, the first resource scheduling mode is represented by 0, and the second resource scheduling mode is represented by 1. When the access point sends the first resource scheduling mode to the STA by using step 102, for example, sets a value of an indication bit to 0, the STA learns from the indication bit that the first resource scheduling mode is obtained, and may locally search for the first transmission resource corresponding to the first resource scheduling mode.

In this embodiment, N resource scheduling modes are determined according to a channel condition and/or history service load statistics, and then in step 101, a resource scheduling mode is determined from the N resource scheduling modes according to channel contention information. Because the channel contention information may reflect a current case of the service load statistics, the resource scheduling mode determined in this manner is applicable to a current network status, and this manner is suitable.

Optionally, before step 101, the method further includes: receiving, by the access point, a declaration sent by the STA, where the declaration is used to declare that the STA has a service to be periodically or persistently scheduled. That is, step 101 or step 102 may be performed when the STA has a service to be periodically or persistently scheduled, so as to meet a requirement of the STA for periodic or persistent transmission; however, if the STA has no service to be periodically or persistently scheduled, the access point may perform processing according to an existing manner. Certainly, whether the STA has the foregoing declaration may be not considered, and the access point performs step 101, and performs step 102 in a broadcast manner.

In another aspect, after receiving the declaration sent by the STA, the access point may further send, to the STA, a location that is of the transmission resource corresponding to each of the N resource scheduling modes and determined for the STA. For example, when the transmission resources corresponding to the N resource scheduling modes are calculated, only sizes, such as two PRBs, of the transmission resources may be determined (that is, the N resource scheduling modes indicate only sizes of the transmission resources); however, a location of a transmission resource used by each STA is not determined, for example, a start subcarrier and an end subcarrier are not determined, and even subcarriers of the two PRBs are not consecutive. In this case, after the foregoing declaration is received, the location that is of the transmission resource corresponding to each resource scheduling mode and determined for the STA may be sent to the STA in a unicast manner, for example, the two PRBs are corresponding to a location from the 0^{th} subcarrier to the 23^{th} subcarrier. In this embodiment of this application, one PRB is defined as a period of time in a time domain and n subcarriers in a frequency domain, where n and N are positive integers. In the foregoing embodiments and subsequent embodiments, that one PRB includes 12 subcarriers is used as an example for description.

Certainly, if when the transmission resources corresponding to the N resource scheduling modes are being calculated, not only the sizes of the transmission resources are calculated, but also the location of the transmission resource used by each STA is determined, when sending the transmission resource information in step 102, the STA may learn the location of the transmission resource of the STA. Certainly, even though no information about the location of the transmission resource is sent when the transmission resource information is being sent in step 102, the location of the transmission resource of the STA may be learned by using information preset or preconfigured in a system, that is, the resource scheduling mode may indicate both the size of the transmission resource and the location of the transmission resource. For example, when determining a resource scheduling mode and a transmission resource, the access point determines time-frequency information of a transmission resource in each resource scheduling mode. For example, in a first resource scheduling mode, a transmission resource of one PRB from the 0^{th} subcarrier to the 11^{th} subcarrier for a first time period is associated with an identifier of a STA 1; a transmission resource of one PRB from the 0^{th} subcarrier to the 11^{th} subcarrier for a second time period is associated with an identifier of a STA 2. Therefore, after the access point broadcasts the correspondences between the resource scheduling modes and the transmission resources to all STAs, when receiving indication information of a transmission resource, that is, the first resource scheduling mode, the STA1 may determine a size and location of the transmission resource of the STA1 according to the first resource scheduling mode and the identifier of the STA1. There is a similar process for the STA2.

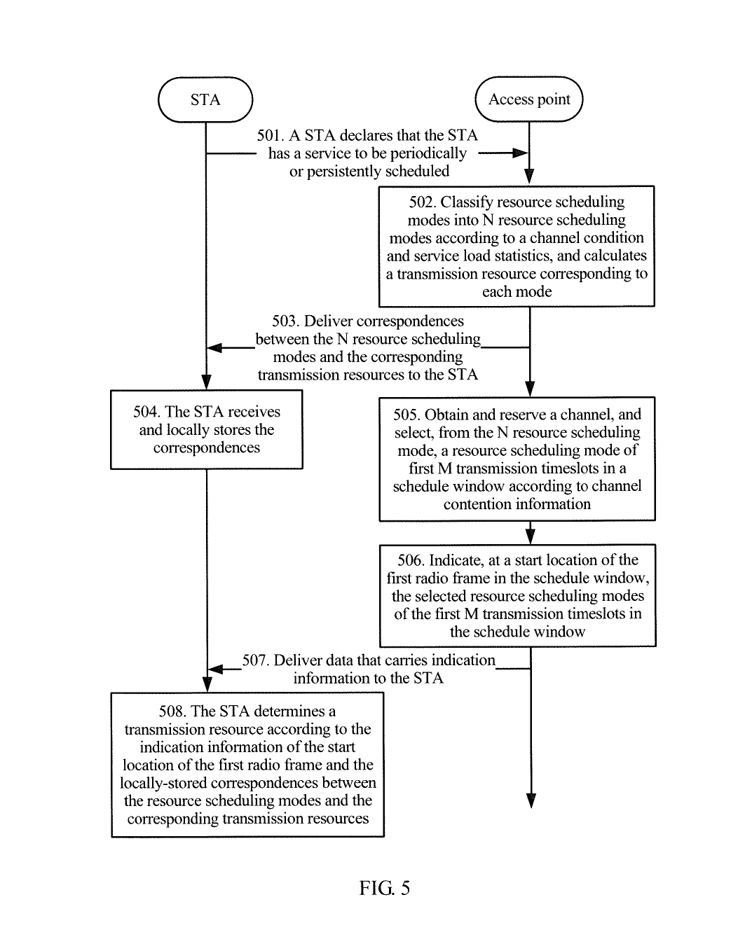

The method process shown in FIG. 3 is described on an access point side. Further, referring to FIG. 4, FIG. 4 is a method flowchart of a transmission resource determining method on a STA side in this embodiment. As shown in FIG. 4, the method includes:

Step 201: A station STA receives transmission resource information sent by a wireless local area network access point, where the transmission resource information is specifically transmission resource information that is of first M transmission timeslots starting from the first timeslot in a schedule window and determined by the access point when the access point obtains a right of using a channel, and M is a positive integer.

Step 202: The STA determines a transmission resource of the STA according to the transmission resource information, where the transmission resource is a transmission resource in an unlicensed frequency band.

Step 202 may be specifically implemented in many possible manners. For example, the STA may directly determine the transmission resource of the STA according to the transmission resource information when the transmission resource information is specifically one or a combination of a size of the transmission resource and a location of the transmission resource.

For another example, when the transmission resource information is specifically indication information, the STA may obtain, according to the indication information, the transmission resource corresponding to the indication information. The indication information is used to indicate resource configuration information corresponding to the indication information. For example, the indication information is 0 or 1. A data amount of the indication information is small; therefore, this manner can reduce scheduling overheads and save resources.

Further, when the transmission resource information is specifically the indication information, the STA may specifically calculate, according to a predetermined rule, a transmission resource corresponding to the indication information, where the predetermined rule may be specifically broadcast to the STA by the access point, or may be specified in a protocol.

Optionally, when the indication information of the transmission resource is specifically a resource scheduling mode, the STA may determine, according to the resource scheduling mode, a transmission resource corresponding to the resource scheduling mode. This manner may be applicable to the foregoing scenario in which the access point calculates resource configuration information corresponding to each resource scheduling mode, and sends the correspondence to the STA. For example, if the indication information is 0, it may be determined that the resource scheduling mode is a first resource scheduling mode, and then a transmission resource corresponding to the first resource scheduling mode is queried, where queried information includes but is not limited to a size and/or a location of the transmission resource.

Further, in this manner, before the step, the STA may further receive correspondences that are between the N resource scheduling modes and transmission resources and sent by the access point. Certainly, the correspondences may also be specified in a protocol.

Optionally, before step 201, the STA may send a declaration to the access point, where the declaration is used to declare that the STA has a service to be periodically or persistently scheduled. In one aspect, after receiving the declaration, the access point may start to perform step 201 and step 202, or certainly, the access point may perform step 101 and step 102 without depending on the declaration. In another aspect, the STA may learn, from the N resource scheduling modes, a location of a transmission resource, of the STA, corresponding to each resource scheduling mode. If the foregoing N resource scheduling modes indicate only sizes of the transmission resources, the STA may receive the location that is of the transmission resource corresponding to each resource scheduling mode and determined by the access point for the STA according to the declaration. That is, step 202 may specifically include: determining, by the STA, a size of the transmission resource according to a resource scheduling mode corresponding to indication information; determining, by the STA, according to a location that is of a transmission resource corresponding to each of the N resource scheduling modes and determined for the STA, a location of the transmission resource corresponding to the resource scheduling mode corresponding to the indication information as a location of the transmission resource of the STA.

Optionally, for uplink transmission, when the transmission resource is determined in step 202, the STA sends data on the transmission resource; for downlink transmission, when the transmission resource is determined in step 202, the STA receives data on the transmission resource.

For example, after step 202, the method further includes: at intervals of a transmission period, when the access point obtains the right of using the channel, sending or receiving, by the STA, data on the determined transmission resource by using the channel.

Optionally, each of the first M transmission timeslots is corresponding to one of the N resource scheduling modes, and step 202 specifically includes: determining, by the STA at intervals of a transmission period, whether the access point obtains the right of using the channel; when the access point obtains the right of using the channel, determining, by the STA according to a loading status of the STA, a resource scheduling mode that needs to be used; and determining, from the first M timeslots, a timeslot that matches the resource scheduling mode that the STA needs to use, and determining one or a combination of a size of a transmission resource and a location of the transmission resource that are correspondingly indicated by the resource scheduling mode that the STA needs to use. Specifically, the STA determines, according to the foregoing correspondences and the resource scheduling mode that the STA needs to use, one or a combination of the size of the transmission resource and the location of the transmission resource that are correspondingly indicated by the resource scheduling mode that the STA needs to use.

Further, the STA sends or receives data on the determined transmission resource by using the channel.

The STA determines, according to the loading status of the STA, the resource scheduling mode that needs to be used. Specifically, the STA may determine, according to a quantity of packets buffered by the STA, the resource scheduling mode that needs to be used. For example, if one packet is buffered, it may be determined that the resource scheduling mode that the STA needs to use is a resource scheduling mode in which a size of a transmission resource is small; if two packets are buffered, it may be determined that the resource scheduling mode that the STA needs to use is a resource scheduling mode in which a size of a transmission resource is two times the size of the foregoing transmission resource.

Then, because the access point has already determined a resource scheduling mode for each transmission timeslot, the STA may choose to send or receive data in the timeslot that matches the resource scheduling mode that the STA needs to use.

Further, in a selection process, determining may be first performed on the first transmission timeslot, and when the first transmission timeslot is unsuitable, whether the second transmission timeslot is suitable is determined. Determining is performed sequentially until a suitable transmission timeslot is found.

Referring to FIG. 5, FIG. 5 is a flowchart of a possible interaction between a STA and an access point in a transmission resource determining method according to an embodiment.

501. The STA declares that the STA has a service to be periodically or persistently scheduled.

502. The access point classifies resource scheduling modes into N modes according to a channel condition and service load statistics, and calculates a transmission resource corresponding to each mode.

503. The access point delivers correspondences between the N resource scheduling modes and the corresponding transmission resources to the STA.

504. After receiving the correspondences between the N resource scheduling modes and the corresponding transmission resources, the STA locally stores the correspondences. A sequence for executing declaring, by the STA, that the STA has a service to be periodically or persistently scheduled and determining, by the access point, the N modes is not limited to this, and the declaring and the determining may be executed in a reverse order.

505. The access point obtains and reserves a channel (where reference may be made to the patent application PCT/CN2014/072617 of the applicant), and selects, from the N resource scheduling modes, a resource scheduling mode of first M transmission timeslots in a schedule window.

506. The access point indicates, at a start location of the first radio frame in the schedule window, the selected resource scheduling mode of the first M transmission timeslots in the schedule window.

507. The access point delivers data that carries indication information to the STA.

508. The STA determines a transmission resource according to the indication information of the start location of the first radio frame and the locally-stored correspondences between the resource scheduling modes and the corresponding transmission resources, and further sends or receives data on the determined transmission resource.

The following separately uses several specific examples to describe some details about the foregoing transmission resource determining methods.

### EXAMPLE 1

In this embodiment, a STA sends a declaration to a wireless local area network access point to declare that the STA needs periodic scheduling, and then the wireless local area network access point sends, to the STA, a location that is of a transmission resource corresponding to each of N resource scheduling modes and determined for the STA. For example, in a first resource scheduling mode, a frequency domain location of a transmission resource of the STA is from the 0^{th} subcarrier to the 23^{th} subcarrier; in a second resource scheduling mode, a frequency domain location of a transmission resource of the STA is from the 0^{th} subcarrier to the 47^{th} subcarrier.

Then, the access point determines a resource scheduling mode of the first transmission timeslot in a schedule window after obtaining a right of using a channel, and broadcasts the resource scheduling mode of the first transmission timeslot to all STAs, and then each STA may receive the resource scheduling mode of the first transmission timeslot. For example, the resource scheduling mode of the first transmission timeslot is the first resource scheduling mode.

However, the STA determines a size of the transmission resource according to the resource scheduling mode. For example, a size of a transmission resource corresponding to the first resource scheduling mode is two PRBs.

Then, if a time consumed for contention does not exceed one transmission period, at intervals of the transmission period, the STA has the right of using the channel, and therefore, the STA may send or receive data on two PRBs corresponding to a location from the 0^{th} subcarrier to the 11^{th} subcarrier in the first transmission timeslot.

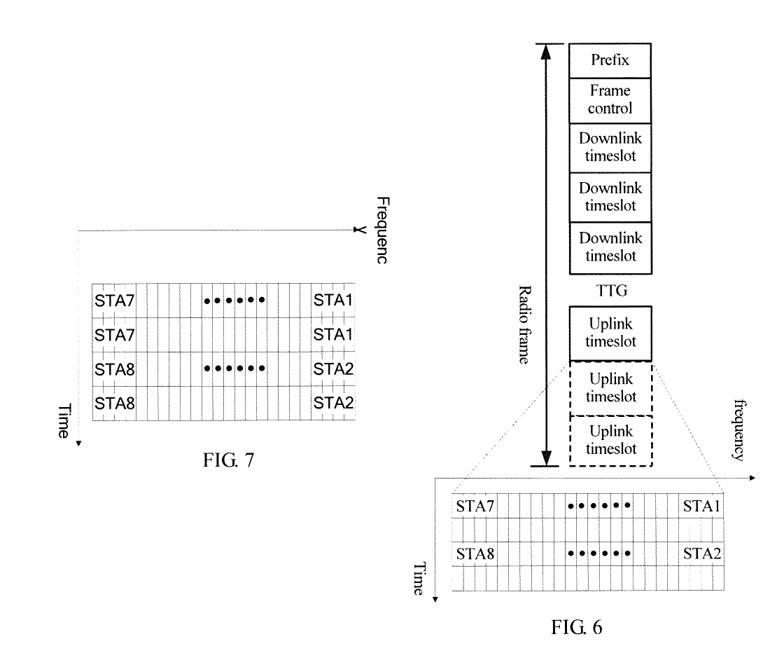

A VoIP (Voice over IP, Voice over Internet Protocol) service is used as an example for description. A voice service has an obvious service feature, a period for generating a packet for a typically encoded VoIP service is 20 ms, and a size of each packet is approximately 86 bytes. It is assumed that in parameter design of scheduling-based access, four PRBs are needed to bear data of 86 bytes: if a time consumed for contending for the channel by the access point meets a requirement of a period of 20 ms, the access point allocates, to each STA, time frequency resources that do not mutually overlap in the first transmission timeslot of each radio frame, a STA that has the VoIP service transmits, in the first transmission timeslot appeared after an interval of 20 ms, data according to resource allocation in FIG. 6, and a STA 1 to a STA 8 transmit data on four PRBs of each of the STA 1 to the STA 8, which achieves an effect of pseudo-periodic scheduling. One PRB is one cell. It should be noted that even though STAs have a same transmission period, because period start points of the STAs may be different, period time points of the STAs may be different.

### EXAMPLE 2

In this embodiment, considering an uncertainty caused by contention-based access, an uncertainty of an access delay exists, and there may be a case in which the access point may obtain, after a longer time, a right of using a channel, that is, a time consumed for contention is longer, for example, the cases in FIG. 2b and FIG. 2c. In this case, a STA that has a periodic service, such as a VoIP service, may buffer a large amount of data that needs to be transmitted, for example, buffer two VoIP packets, which is corresponding to a status of heavy service load. If the foregoing transmission resource determined in Example 1 is used, only one packet can be sent, and another buffered packet cannot be sent in a timely manner.

Therefore, the access point learns, from a time consumed for contention, that the time consumed for contention exceeds two periods, and therefore, determines transmission resource information of the first transmission timeslot. Compared with Example 1, a transmission resource corresponding to the transmission resource information in this embodiment is, for example, two times the transmission resource in Example 1; and is, for example, eight PRBs. It is assumed that a first resource scheduling mode is used in Example 1 and a second resource scheduling mode is used in this embodiment, indication is performed at a start location of the first radio frame in a schedule window. After receiving indication information, each STA determines a transmission resource, and then sends two packets on eight PRBs shown in FIG. 7. As shown in FIG. 7, the transmission resource used by each STA is exactly two times the transmission resource used in FIG. 6.

Further, transmission resource information of remaining transmission timeslots in the schedule window may be determined as, for example, the first resource scheduling mode in Example 1, where the remaining transmission timeslots include a remaining transmission timeslot in the radio frame and transmission timeslots of a following radio frame in the schedule window. The first resource scheduling mode may be implemented in a preset default manner, and the access point does not need to send indication information to the STA, so that scheduling overheads can be reduced. That is, the access point determines, from N resource scheduling modes, a resource scheduling mode used in one or more timeslots of first M transmission timeslots as indication information of a transmission resource of the first M transmission timeslots. Not all resource scheduling modes used in timeslots need to be indicated, and a resource scheduling mode specified in a protocol is used in a timeslot without an indication.

Certainly, in the foregoing example, only the resource scheduling mode of the first transmission timeslot is determined as the second resource scheduling mode. If a time consumed for contention is longer and more data is buffered on a STA side, an increase of transmission resources in only the first transmission timeslot may be not enough. Therefore, a resource scheduling mode of the second transmission timeslot is also determined as the second resource scheduling mode. By analogy, resource scheduling modes of the first M transmission timeslots may be determined as the second resource scheduling mode.

### EXAMPLE 3

In the foregoing Example 2, when the access point uses, in the first transmission timeslot of the first radio frame, the second resource scheduling mode for some STAs (which passes through an interval of 40 ms to 60 ms) that have periodic services, and when other STAs (which passes through an interval of 20 ms to 40 ms) that have periodic services are exactly in the first resource scheduling mode, a conflict may occur.

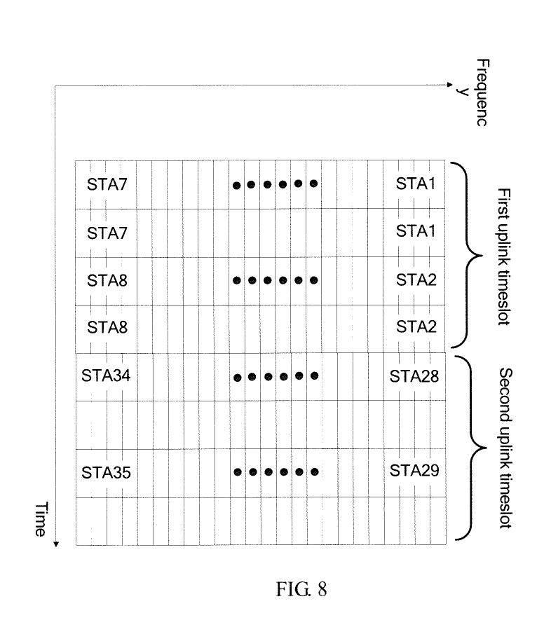

Therefore, in this case, when the access point enters a scheduling mode by using a contention-based access channel, one part of users may buffer two packets, and the other part of users may buffer only one packet. In this case, when scheduling is performed according to the solutions in the foregoing Example 1 and Example 2, the two parts of STAs may simultaneously perform transmission in the first transmission timeslot of the first radio frame, and therefore, a collision may occur. To avoid this problem, when a STA (such as a STA of a STA 28 to a STA 35 shown in FIG. 8) needs to perform transmission in the first transmission timeslot of the first radio frame by using the first resource scheduling mode, before sending data, the STA checks whether the access point allocates another resource scheduling mode to the first transmission timeslot. After entering a contention window, the access point may indicate, at a start location of the window, a resource scheduling mode of the first transmission timeslot of the first radio frame. Therefore, the STA may learn, from the information, that whether another resource scheduling mode is arranged for the first transmission timeslot of the first radio frame. If there is another resource scheduling mode, such as the second resource scheduling mode, a STA that needs to perform transmission according to the first resource scheduling mode automatically performs transmission in the second uplink subframe of the first radio frame by using the first resource scheduling mode, and a STA (such as a STA of a STA 1 to a STA 8 shown in FIG. 8) that needs to perform transmission according to the second resource scheduling mode performs transmission in the first transmission timeslot of the first radio frame by using the second resource scheduling mode. In this way, the foregoing collision problem is effectively avoided.

It should be noted that the above description is only an example. In a practical application, another case may further exist. For example, if a resource scheduling mode of the first transmission timeslot is a third resource scheduling mode, and a resource scheduling mode of the second transmission timeslot is the second resource scheduling mode, the STA that needs to perform transmission according to the first resource scheduling mode continues to determine whether a resource scheduling mode of the third transmission timeslot matches the resource scheduling mode needed by the STA. When the resource scheduling mode of the third transmission timeslot matches the resource scheduling mode needed by the STA, the STA sends or receives data in the third transmission timeslot; if the resource scheduling mode of the third transmission timeslot does not match the resource scheduling mode needed by the STA, the STA continues to determine whether a resource scheduling mode of a subsequent transmission timeslot matches the resource scheduling mode needed by the STA, until the STA finds a transmission timeslot in which a resource scheduling mode matches the resource scheduling mode needed by the STA.

Optionally, a STA determines, according to an amount of data buffered by the STA, a resource scheduling mode needed by the STA; or determines, according to a time waited by the STA, a resource scheduling mode needed by the STA.

### EXAMPLE 4

This embodiment describes transmission of an uplink small-size packet service, such as a VDI (Virtual Desktop Infrastructure, virtual desktop infrastructure) service. In a VDI application, a wireless office service is one of the most primary services of the VDI application. In the wireless office service, uplink transmission is completely transmission of a small-sized packet less than 80 bytes, and the small-sized packet is generally control information of a mouse and a keyboard. For these random and frequent uplink small-size packet services, if traditional dynamic scheduling is used, a large amount of uplink scheduling request signaling and scheduling indication signaling of a downlink control channel may be generated, which extremely increases scheduling signaling overheads and imposes an extremely high requirement on a capacity of a control channel. Therefore, in some solutions, an access point may allocate a fixed resource to a STA, but at a specific time point, the resource may not be fully used, and a waste is caused. In this embodiment, multiple resource scheduling modes are preset to flexibly deal with an uncertainty of a channel access delay, so as to improve spectrum utilization and reduce a waste of spectrum resources. For example, when a time consumed for contention is relatively long, the access point allocates a relatively large resource block to the STA; if a time consumed for contention is relatively short, the access point allocates a relatively small resource block to the STA, so as to avoid that scheduling with a fixed resource block causes a waste of spectrum resources, or that a packet cannot be transmitted in a timely manner.

Further, the access point may allocate a larger resource block in the first transmission timeslot to a STA 1, and allocate smaller resource blocks in the second transmission timeslot and a subsequent transmission timeslot to other STA.

### EXAMPLE 5

This embodiment describes another implementation manner of uplink transmission of an uplink small-size packet service, such as a VDI service. For random and frequent uplink small-size packet services in a VDI application, in order to avoid a problem of increasing scheduling signaling overheads caused because a large amount of uplink scheduling request signaling and scheduling indication signaling of a downlink control channel is generated in traditional dynamic scheduling, a group-based scheduling manner is proposed in some solutions: An AP groups STAs that have VDI services, and performs periodic scheduling by groups, where each group occupies a resource of one transmission timeslot. For example, a first group of STAs is scheduled in the first transmission timeslot, and a second group of STAs is scheduled in the second transmission timeslot. Each time the AP schedules a resource for a group of users, a user in the group finds a resource of the group according to a group identifier, and finds a specific resource of the user according to an intra-group identifier. In this group-based scheduling manner, the above-described problem, such as a problem caused by a contention delay, that may occur in an unlicensed frequency band still exists. To resolve this problem, in this embodiment, a transmission resource of each group of STAs may be determined according to contention information. For example, when a time consumed for contention is relatively long, multiple groups of STAs or all groups of STAs may be simultaneously scheduled in the first transmission timeslot. For example, a first group of STAs and a second group of STAs are simultaneously scheduled in the first transmission timeslot. If all data still cannot be completely transmitted, at least one group of STAs, such as the first group of STAs, may continue to be scheduled in the second transmission timeslot, so as to resolve a data buffering problem caused by a delay. If the time consumed for contention is relatively short, each group of STAs may be scheduled in an existing manner, that is, each group occupies a resource of one transmission timeslot.

Certainly, the following solution may be used: a relatively large resource block is allocated to each group of STAs in each transmission timeslot.

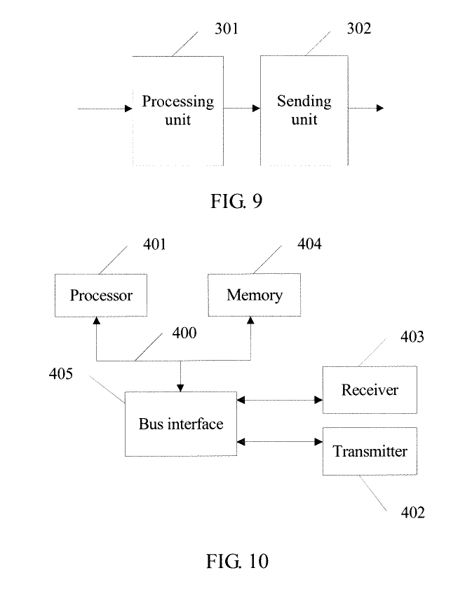

Based on a same disclosure concept, an embodiment of this application provides a wireless local area network access point. For meanings of involved terms and specific implementation of the access point shown in FIG. 9, reference may be made to related descriptions of FIG. 3 to FIG. 8 and the foregoing embodiments.

Referring to FIG. 9, the access point includes: a processing unit 301, configured to determine transmission resource information of first M transmission timeslots in a schedule window when obtaining a right of using a channel, where the channel is a channel in an unlicensed frequency band, and M is a positive integer; and a sending unit 302, configured to send the transmission resource information to a station STA after entering the schedule window.

Optionally, the processing unit 301 is specifically configured to determine the transmission resource information of the first M transmission timeslots in the schedule window according to one or a combination of a time consumed for contention and bandwidth of the channel, where a longer time consumed for contention or lower bandwidth indicates more determined transmission resources to be allocated to the first M transmission timeslots.

Optionally, the transmission resource information is specifically: one or a combination of a size of a transmission resource and a location of the transmission resource; or indication information of a transmission resource.

Optionally, the processing unit 301 is specifically configured to determine, from N resource scheduling modes, a resource scheduling mode used in one or more timeslots of the first M transmission timeslots as the indication information of the transmission resource of the first M transmission timeslots, where N is an integer greater than or equal to 2, transmission resources corresponding to the N resource scheduling modes are not exactly the same as each other, and the N resource scheduling modes are specified in a protocol or predetermined by the access point.

Further, the processing unit 301 is further configured to: when the N resource scheduling modes are predetermined by the access point, determine the N resource scheduling modes, and calculate a transmission resource corresponding to each of the N resource scheduling modes. The sending unit 302 is further configured to send correspondences between the N resource scheduling modes and the transmission resources to the STA.

Optionally, the processing unit 301 is specifically configured to determine, from the N resource scheduling modes, one resource scheduling mode for each of the first M transmission timeslots.

With reference to the foregoing embodiments, the processing unit 301 is specifically configured to determine the N resource scheduling modes according to one or a combination of a channel condition and service load statistics.

With reference to the foregoing embodiments, the access point further includes a receiving unit.

The receiving unit is configured to receive a declaration sent by the STA, where the declaration is used to declare that the STA has a service to be periodically or persistently scheduled.

Further, the sending unit 302 is further configured to: when the resource scheduling mode indicates only a size of a transmission resource, send, to the STA, a location that is of a transmission resource corresponding to each of the N resource scheduling modes and determined for the STA according to the declaration.

The various types of variations and specific instances in the transmission resource determining method in the foregoing embodiment in FIG. 3 are also applicable to the access point in this embodiment. With the foregoing detailed descriptions of the transmission resource determining method, a person of ordinary skill in the art can clearly understand the implementation method of the access point in this embodiment. Therefore, for brevity of this specification, details are not described herein again.

Based on a same disclosure concept, the embodiments further provide a wireless local area network access point. For meanings of involved terms and specific implementation of the access point shown in FIG. 10, reference may be made to related descriptions of FIG. 3 to FIG. 8 and the foregoing embodiments.

Referring to FIG. 10, FIG. 10 is a concept diagram of an instance of hardware implementation of an access point according to an embodiment. The access point includes: a processor 401, configured to determine transmission resource information of first M transmission timeslots in a schedule window when obtaining a right of using a channel, where the channel is a channel in an unlicensed frequency band, and M is a positive integer; and a transmitter 402, configured to send the transmission resource information to a station STA after entering the schedule window.

Optionally, the processor 401 is specifically configured to determine the transmission resource information of the first M transmission timeslots in the schedule window according to one or a combination of a time consumed for contention and bandwidth of the channel, where a longer time consumed for contention or lower bandwidth indicates more determined transmission resources to be allocated to the first M transmission timeslots.

Optionally, the transmission resource information is specifically: one or a combination of a size of a transmission resource and a location of the transmission resource; or indication information of a transmission resource.

Optionally, the processor 401 is specifically configured to determine, from N resource scheduling modes, a resource scheduling mode used in one or more timeslots of the first M transmission timeslots as the indication information of the transmission resource of the first M transmission timeslots, where N is an integer greater than or equal to 2, transmission resources corresponding to the N resource scheduling modes are not exactly the same as each other, and the N resource scheduling modes are specified in a protocol or predetermined by the access point.

Optionally, the processor 401 is further configured to: when the N resource scheduling modes are predetermined by the access point, determine the N resource scheduling modes, and calculate a transmission resource corresponding to each of the N resource scheduling modes. The transmitter 402 is further configured to send correspondences between the N resource scheduling modes and the transmission resources to the STA.

Optionally, the processor 401 is specifically configured to determine, from the N resource scheduling modes, one resource scheduling mode for each of the first M transmission timeslots.

With reference to the foregoing embodiments, the processor 401 is specifically configured to determine the N resource scheduling modes according to one or a combination of a channel condition and service load statistics.

With reference to the foregoing embodiments, the access point further includes a receiver 403.

The receiver 403 is configured to receive a declaration sent by the STA, where the declaration is used to declare that the STA has a service to be periodically or persistently scheduled.

Further, when the resource scheduling mode indicates only a size of a transmission resource, the transmitter 402 is further configured to send, to the STA, a location that is of a transmission resource corresponding to each of the N resource scheduling modes and determined for the STA according to the declaration.

Further, in FIG. 10, a bus architecture (which is indicated by using a bus 400): the bus 400 may include any quantity of interconnected buses and bridges, and the bus 400 interconnects various circuits including one or more processors represented by the processor 401 and a memory represented by the memory 404. The bus 400 may further link various other circuits such as a peripheral device, a voltage regulator, and a power management circuit, which are well known in the art, and therefore are not further described in this specification. A bus interface 405 provides interfaces between the bus 400 and a receiver 403 and between the bus 400 and a transmitter 402. The receiver 403 and the transmitter 402 may be a same component: a transceiver. The transceiver provides a unit configured to communicate with various other apparatuses on a transmission medium.

The processor 401 is responsible for managing the bus 400 and general processing. The memory 404 may be configured to store data used when the processor 401 executes an operation.

The various types of variations and specific instances in the transmission resource determining method in the foregoing embodiment in FIG. 3 are also applicable to the access point in this embodiment. With the foregoing detailed descriptions of the transmission resource determining method, a person of ordinary skill in the art can clearly understand the implementation method of the access point in this embodiment. Therefore, for brevity of this specification, details are not described herein again.

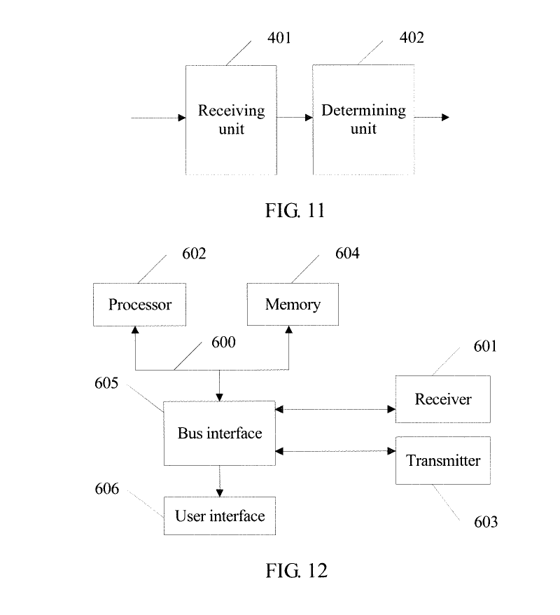

Based on a same disclosure concept, the embodiments provide a station. Referring to FIG. 11, the station includes: a receiving unit 501, configured to receive transmission resource information sent by a wireless local area network access point, where the transmission resource information is specifically transmission resource information that is of first M transmission timeslots starting from the first timeslot in a schedule window and determined by the access point when the access point obtains a right of using a channel, and M is a positive integer; and a determining unit 502, configured to determine a transmission resource of the STA according to the transmission resource information, where the transmission resource is a transmission resource in an unlicensed frequency band.

Optionally, the determining unit 502 is specifically configured to:

determine the transmission resource information as the transmission resource of the station when the transmission resource information is specifically one or a combination of a size of the transmission resource and a location of the transmission resource; or

when the transmission resource information is specifically indication information of the transmission resource, determine, according to a predetermined rule, the transmission resource corresponding to the indication information.

Optionally, the determining unit 502 is specifically configured to: when the indication information of the transmission resource is a resource scheduling mode, determine the transmission resource according to the resource scheduling mode.

Optionally, the determining unit 502 is specifically configured to: when each of the first M transmission timeslots is corresponding to one of N resource scheduling modes, where N is an integer greater than or equal to 2, and transmission resources corresponding to the N resource scheduling modes are not exactly the same as each other, determine, at intervals of a transmission period, whether the access point obtains the right of using the channel; when the access point obtains the right of using the channel, determine, according to a loading status of the station, a resource scheduling mode that needs to be used; and determine, from the first M timeslots, a timeslot that matches the resource scheduling mode that the station needs to use, and determine one or a combination of a size of a transmission resource and a location of the transmission resource that are correspondingly indicated by the resource scheduling mode that the station needs to use.

Optionally, the receiving unit 501 is further configured to receive and save correspondences that are between the N resource scheduling modes and the transmission resources and sent by the access point; and the determining unit 502 is specifically configured to determine, according to the correspondences and the resource scheduling mode that the station needs to use, one or a combination of the size of the transmission resource and the location of the transmission resource that are correspondingly indicated by the resource scheduling mode that the station needs to use.

Optionally, the station further includes a sending unit.

The sending unit is configured to send a declaration to the access point, where the declaration is used to declare that the station has a service to be periodically or persistently scheduled.

Optionally, the receiving unit 501 is further configured to: when the resource scheduling mode indicates only a size of a transmission resource, receive a location that is of a transmission resource corresponding to each of the N resource scheduling modes and determined by the access point for the station according to the declaration.

Optionally, the station further includes a sending unit.

The receiving unit 501 is further configured to: at intervals of the transmission period, when the access point obtains the right of using the channel, receive data on the determined transmission resource by using the channel.

The sending unit is configured to: at intervals of the transmission period, when the access point obtains the right of using the channel, send data on the determined transmission resource by using the channel.

The various types of variations and specific instances in the transmission resource determining method in the foregoing embodiment in FIG. 4 are also applicable to the station in this embodiment. With the foregoing detailed descriptions of the transmission resource determining method, a person of ordinary skill in the art can clearly understand the implementation method of the station in this embodiment. Therefore, for brevity of this specification, details are not described herein again.

Based on a same disclosure concept, the embodiments provide a station. Referring to FIG. 12, FIG. 12 is a concept diagram of an instance of hardware implementation of a station in this embodiment. The station includes: a receiver 601, configured to receive transmission resource information sent by a wireless local area network access point, where the transmission resource information is specifically transmission resource information that is of first M transmission timeslots in a schedule window and determined by the access point when the access point obtains a right of using a channel, and M is a positive integer; and a processor 602, configured to determine a transmission resource of the STA according to the transmission resource information, where the transmission resource is a transmission resource in an unlicensed frequency band.

Optionally, the processor 602 is specifically configured to:

determine the transmission resource information as the transmission resource of the station when the transmission resource information is specifically one or a combination of a size of the transmission resource and a location of the transmission resource; or

when the transmission resource information is specifically indication information of the transmission resource, determine, according to a predetermined rule, the transmission resource corresponding to the indication information.

Optionally, the processor 602 is specifically configured to: when the indication information of the transmission resource is a resource scheduling mode, determine the transmission resource according to the resource scheduling mode.

Further, the processor 602 is specifically configured to: when each of the first M transmission timeslots is corresponding to one of N resource scheduling modes, where N is an integer greater than or equal to 2, and transmission resources corresponding to the N resource scheduling modes are not exactly the same as each other, determine, at intervals of a transmission period, whether the access point obtains the right of using the channel; when the access point obtains the right of using the channel, determine, according to a loading status of the station, a resource scheduling mode that needs to be used; and determine, from the first M timeslots, a timeslot that matches the resource scheduling mode that the station needs to use, and determine one or a combination of a size of a transmission resource and a location of the transmission resource that are correspondingly indicated by the resource scheduling mode that the station needs to use.

Optionally, the receiver 601 is further configured to receive and save correspondences that are between the N resource scheduling modes and the transmission resources and sent by the access point; and the processor 602 is specifically configured to determine, according to the correspondences and the resource scheduling mode that the station needs to use, one or a combination of the size of the transmission resource and the location of the transmission resource that are correspondingly indicated by the resource scheduling mode that the station needs to use.

Optionally, the station further includes a transmitter 603.

The transmitter 603 is configured to send a declaration to the access point, where the declaration is used to declare that the STA has a service to be periodically or persistently scheduled.

Optionally, the receiver 601 is further configured to: when the resource scheduling mode indicates only a size of a transmission resource, receive a location that is of a transmission resource corresponding to each of the N resource scheduling modes and determined by the access point for the station according to the declaration.

With reference to the foregoing embodiments, the station further includes a transmitter 603.

The receiver 601 is further configured to: at intervals of the transmission period, when the access point obtains the right of using the channel, receive data on the determined transmission resource by using the channel.

The transmitter 603 is configured to: at intervals of the transmission period, when the access point obtains the right of using the channel, send data on the determined transmission resource by using the channel.

Further, in FIG. 12, a bus architecture (which is indicated by using a bus 600): the bus 600 may include any quantity of interconnected buses and bridges, and the bus 600 interconnects various circuits including one or more processors represented by the processor 602 and a memory represented by the memory 604. The bus 600 may further link various other circuits such as a peripheral device, a voltage regulator, and a power management circuit, which are well known in the art, and therefore are not further described in this specification. A bus interface 605 provides interfaces between the bus 600 and a receiver 601 and between the bus 600 and a transmitter 603. The receiver 601 and the transmitter 603 may be a same component: a transceiver. The transceiver provides a unit configured to communicate with various other apparatuses on a transmission medium. Depending on nature of user equipment, a user interface 606 may further be provided, for example, a keypad, a display, a loudspeaker, a microphone, and a joystick.

The processor 602 is responsible for managing the bus 600 and general processing. The memory 604 may be configured to store data used when the processor 602 executes an operation.

The various types of variations and specific instances in the transmission resource determining method in the foregoing embodiment in FIG. 4 are also applicable to the station in this embodiment. With the foregoing detailed descriptions of the transmission resource determining method, a person of ordinary skill in the art can clearly understand the implementation method of the station in this embodiment. Therefore, for brevity of this specification, details are not described herein again.

One or more technical solutions provided in the embodiments of this application have at least the following technical effects or advantages:

In the transmission resource determining method provided in the embodiments of this application, when obtaining a right of using a channel, an access point determines information about a transmission resource allocated to a STA in each transmission timeslot, such as a size or a location of a resource. Therefore, this transmission resource determining manner is more flexible, can better meet a transmission requirement of the STA, and can ensure quality of service QoS for a service that needs to be periodically transmitted or persistently transmitted. Correspondingly, the station determines a suitable transmission resource according to a loading status of the station, which not only meets a transmission requirement of the STA, but also reduces system resource use conflicts or a waste of system resources.

A person skilled in the art should understand that the embodiments of this application may be provided as a method, a system, or a computer program product. Therefore, this application may use a form of hardware only embodiments, software only embodiments, or embodiments with a combination of software and hardware. Moreover, this application may use a form of a computer program product that is implemented on one or more computer-usable storage media (which include but are not limited to a disk memory, an optical memory, and the like) that include computer-usable program code.

This application is described with reference to the flowcharts and/or block diagrams of the method, the device (system), and the computer program product according to the embodiments of this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Apparently, a person skilled in the art can make various modifications and variations to this application without departing from the spirit and scope of this application. This application is intended to cover these modifications and variations of this application provided that they fall within the scope of protection defined by the following claims and their equivalent technologies.

What is claimed is:

1. A transmission resource determining method, comprising:
determining, by a wireless local area network access point, transmission resource information of first M transmission timeslots in a schedule window when obtaining a right of using a channel, wherein the channel is a wireless channel in an unlicensed frequency band, and M is a positive integer; and
sending, by the access point, the transmission resource information to a station STA after entering the schedule window.

2. The method according to claim 1, wherein the determining transmission resource information of first M transmission timeslots in a schedule window comprises:
determining, by the access point, the transmission resource information of the first M transmission timeslots in the schedule window according to one or a combination of a time consumed for contention and bandwidth of the channel, wherein a longer time consumed for contention or lower bandwidth indicates more determined transmission resources to be allocated to the first M transmission timeslots.

3. The method according to claim 1, wherein the transmission resource information is specifically: one or a combination of a size of a transmission resource and a location of the transmission resource; or indication information of a transmission resource.

4. The method according to claim 3, wherein the determining transmission resource information of first M transmission timeslots in a schedule window comprises:
determining, by the access point from N resource scheduling modes, a resource scheduling mode used in one or more timeslots of the first M transmission timeslots as the indication information of the transmission resource of the first M transmission timeslots, wherein N is an integer greater than or equal to 2, transmission resources corresponding to the N resource scheduling modes are not exactly the same as each other, and the N resource scheduling modes are specified in a protocol or predetermined by the access point.

5. The method according to claim 4, wherein when the N resource scheduling modes are predetermined by the access point, before the access point obtains the right of using the channel, the method further comprises:
determining, by the access point, the N resource scheduling modes;
calculating, by the access point, a transmission resource corresponding to each of the N resource scheduling modes; and
sending, by the access point, correspondences between the N resource scheduling modes and the transmission resources to the STA.

6. A transmission resource determining method, comprising:
receiving, by a station STA, transmission resource information sent by a wireless local area network access point, wherein the transmission resource information is specifically transmission resource information that is of first M transmission timeslots in a schedule window and determined by the access point when the access point obtains a right of using a channel, and M is a positive integer; and
determining, by the STA, a transmission resource of the STA according to the transmission resource information, wherein the transmission resource is a transmission resource in an unlicensed frequency band.

7. The method according to claim 6, wherein the determining, by the STA, a transmission resource of the STA according to the transmission resource information comprises:
determining, by the STA, the transmission resource information as the transmission resource of the STA when the transmission resource information is specifically one or a combination of a size of the transmission resource and a location of the transmission resource; or when the transmission resource information is specifically indication information of the transmission resource, determining, by the STA according to a predetermined rule, the transmission resource corresponding to the indication information.

8. The method according to claim 7, wherein the indication information of the transmission resource is a resource scheduling mode; and
the determining, by the STA according to a predetermined rule, the transmission resource corresponding to the indication information specifically comprises: determining, by the STA, the transmission resource according to the resource scheduling mode.

9. The method according to claim 8, wherein when each of the first M transmission timeslots is corresponding to one of N resource scheduling modes, wherein N is an integer greater than or equal to 2, and transmission resources corresponding to the N resource scheduling modes are not exactly the same as each other, the determining, by the STA, a transmission resource of the STA according to the transmission resource information specifically comprises:
determining, by the STA at intervals of a transmission period, whether the access point obtains the right of using the channel;
when the access point obtains the right of using the channel, determining, by the STA according to a loading status of the STA, a resource scheduling mode that needs to be used; and
determining, from the first M timeslots, a timeslot that matches the resource scheduling mode that the STA needs to use, and determining one or a combination of a size of a transmission resource and a location of the transmission resource that are correspondingly indicated by the resource scheduling mode that the STA needs to use.

10. The method according to claim 9, wherein before the determining, by the STA, the transmission resource according to the resource scheduling mode, the method further comprises:
receiving and saving, by the station STA, correspondences that are between the N resource scheduling modes and the transmission resources and sent by the access point; and
the determining one or a combination of a size of a transmission resource and a location of the transmission resource that are correspondingly indicated by the resource scheduling mode that the STA needs to use specifically comprises:
determining, according to the correspondences and the resource scheduling mode that the STA needs to use, one or a combination of the size of the transmission resource and the location of the transmission resource that are correspondingly indicated by the resource scheduling mode that the STA needs to use.

11. A wireless local area network access point, comprising:
a processing unit, configured to determine transmission resource information of first M transmission timeslots in a schedule window when obtaining a right of using a channel, wherein the channel is a wireless channel in an unlicensed frequency band, and M is a positive integer; and
a sending unit, configured to send the transmission resource information to a station STA after the access point enters the schedule window.

12. The access point according to claim 11, wherein the processing unit is specifically configured to determine the transmission resource information of the first M transmission timeslots in the schedule window according to one or a combination of a time consumed for contention and bandwidth of the channel, wherein a longer time consumed for contention or lower bandwidth indicates more determined transmission resources to be allocated to the first M transmission timeslots.

13. The access point according to claim 11, wherein the transmission resource information is specifically: one or a combination of a size of a transmission resource and a location of the transmission resource; or indication information of a transmission resource.

14. The access point according to claim 13, wherein the processing unit is specifically configured to determine, from N resource scheduling modes, a resource scheduling mode used in one or more timeslots of the first M transmission timeslots as the indication information of the transmission resource of the first M transmission timeslots, wherein N is an integer greater than or equal to 2, transmission resources corresponding to the N resource scheduling modes are not exactly the same as each other, and the N resource scheduling modes are specified in a protocol or predetermined by the access point.

15. The access point according to claim 14, wherein the processing unit is further configured to: when the N resource scheduling modes are predetermined by the access point, determine the N resource scheduling modes, and calculate a transmission resource corresponding to each of the N resource scheduling modes; and
the sending unit is further configured to send correspondences between the N resource scheduling modes and the transmission resources to the STA.

16. A station, comprising:
a receiving unit, configured to receive transmission resource information sent by a wireless local area network access point, wherein the transmission resource information is specifically transmission resource information that is of first M transmission timeslots in a schedule window and determined by the access point when the access point obtains a right of using a channel, and M is a positive integer; and
a determining unit, configured to determine a transmission resource of the station according to the transmission resource information, wherein the transmission resource is a transmission resource in an unlicensed frequency band.

17. The station according to claim 16, wherein the determining unit is specifically configured to: determine the transmission resource information as the transmission resource of the station when the transmission resource information is specifically one or a combination of a size of the transmission resource and a location of the transmission resource; or when the transmission resource information is specifically indication information of the transmission resource, determine, according to a predetermined rule, the transmission resource corresponding to the indication information.

18. The station according to claim 17, wherein the determining unit is specifically configured to: when the indication information of the transmission resource is a resource scheduling mode, determine the transmission resource according to the resource scheduling mode.

19. The station according to claim 18, wherein the determining unit is specifically configured to:
when each of the first M transmission timeslots is corresponding to one of N resource scheduling modes, wherein N is an integer greater than or equal to 2, and transmission resources corresponding to the N resource scheduling modes are not exactly the same as each other, determine, at intervals of a transmission period, whether the access point obtains the right of using the channel; when the access point obtains the right of using the channel, determine, according to a loading status of the station, a resource scheduling mode that needs to be used; and determine, from the first M timeslots, a timeslot that matches the resource scheduling mode that the station needs to use, and determine one or a combination of a size of a transmission resource and a location of the transmission resource that are correspondingly indicated by the resource scheduling mode that the station needs to use.

20. The station according to claim 19, wherein the receiving unit is further configured to receive and save correspondences that are between the N resource scheduling modes and the transmission resources and sent by the access point; and
the determining unit is specifically configured to determine, according to the correspondences and the resource scheduling mode that the station needs to use, one or a combination of the size of the transmission resource and the location of the transmission resource that are correspondingly indicated by the resource scheduling mode that the station needs to use.
